(19) United States
(12) Patent Application Publication
(10) Pub. No.: US 2004/0193476 A1
(43) Pub. Date: Sep. 30, 2004

(54) Data center analysis

(76) Inventor: Reinier J. Aerdts, Plano, TX (US)

Correspondence Address: FISH & RICHARDSON P.C., 1425 K STREET, N.W., 11TH FLOOR, WASHINGTON, DC, 20005-3500, US

(21) Appl. No.: 10/403,790

(22) Filed: Mar. 31, 2003

(51) Int. Cl. G06F 17/60

(52) U.S. Cl. 705/10

(57) ABSTRACT

Techniques are provided for data center analysis. In certain implementations, data center analysis includes evaluating the maturity of each of predefined of data center categories, where each category is associated with a data center resource, and maturity reflects management organization of a category.

### TECHNICAL FIELD

This description relates to data centers, and more particularly, to analyzing data centers.

### BACKGROUND

Application Service Providers (ASPs) manage and distribute software-based services and solutions to customers from one or more locations. Thus, ASPs provide a way for an organization to outsource some or almost all aspects of its information technology needs.

A location used by an ASP to provide the services is typically known as a data center. Basically, a data center is a centralized storage facility used by the ASP to retain database information related to the decision-making processes of an organization. Data centers may play a key role in the rapid deployment and exploitation of business functions as they relate to an organization's ability to take advantage of market opportunities.

### SUMMARY

Techniques are provided for data center analysis. In one general aspect, data center analysis includes evaluating the maturity of each of predefined data center categories, where each category is associated with a data center resource, and maturity reflects management organization of a category. The evaluation may be performed by hand, machine, instructions encoded in a computer-readable medium, or any other appropriate technique.

Particular implementations may include determining an overall data center rating, which may include averaging maturity ratings for the categories. Certain implementations also may include comparing the overall data center rating to a standardized rating. Some implementations may include translating the overall rating into business management areas. Certain implementations also may include determining recommendations for improving the data center based on the maturity of at least one category.

In certain implementations, the categories include physical infrastructure, information technology environment, systems management, globalization, application development, and application infrastructure. Evaluating the maturity of physical infrastructure may include evaluating the maturity of at least one of building, location, security, disaster recovery capability, processes, service excellence, service level management, standardization, network latency, data access latency, pre-emptive auto-recovery, and data center status monitoring capability. Evaluating the maturity of the information technology environment may include evaluating the maturity of at least one of technology refresh process, technology refresh implementation, tactical and strategic planning, real-time client business view, and virtual data center. Evaluating the maturity of systems management may include evaluating the maturity of at least one of performance management, capacity planning, dynamic resource allocation, single consolidated consoles, and information technology processes. Evaluating the maturity of globalization may include evaluating the maturity of at least one of geographic diversity, workload characterization, global standardization, and global processes. Evaluating the maturity of application development may include evaluating the maturity of at least one of standardization, application maturity, and application simplicity. Evaluating the maturity of application infrastructure may include evaluating the maturity of at least one of high availability and virtual applications.

In some implementations, operational infrastructure is an additional category. Evaluating the maturity of operational infrastructure may include evaluating the maturity of at least one of standardization, business continuity, problem and change management, root cause analysis, and lights-out operation.

In certain implementations, evaluating the maturity of a category includes determining a maturity rating for a component of the category.

In another general aspect, data center analysis includes determining an overall data center rating by averaging the maturity ratings for predefined data center categories, including physical infrastructure, information technology environment, systems management, globalization, application development, application infrastructure, and operational infrastructure, where maturity ratings reflect the management organization of the categories. In this analysis, physical infrastructure includes building, location, security, disaster recovery capability, processes, service excellence, service level management, standardization, network latency, data access latency, pre-emptive auto-recovery, and data center status monitoring capability. Information technology environment includes technology refresh process, technology refresh implementation, tactical and strategic planning, real-time client business view, and virtual data center. Systems management includes performance management capacity planning, dynamic resource allocation, single consolidated consoles, and information technology processes. Globalization includes geographic diversity, workload characterization, global standardization, and global processes. Application development includes high availability and virtual applications. Operational infrastructure comprises standardization, business continuity, problem and change management, root cause analysis, and lights-out operation. The analysis also includes comparing the overall data center rating to a standardized rating, translating the overall rating into business management areas, and determining recommendations for improving the data center based on the maturity of at least one category.

The described techniques may be used to provide a standardized way to assess data centers so as to permit organizations to evaluate the effectiveness of data centers offered by different Information Technology Service Providers (ITSPs). The techniques may also be used to give ITSPs an understanding of how their data centers rate relative to other data centers and/or to give ITSPs a plan of how to improve their data centers.

The details of one or more implementations are set forth in the accompanying drawings and the description below. Other features will be apparent from the description and the drawings, and from the claims.

### DESCRIPTION OF DRAWINGS

FIG. 1 is a block diagram illustrating a model for data center analysis.

FIG. 2 is a block diagram illustrating a system for data center analysis.

FIG. 3 is a flow chart illustrating a process for data center analysis.

FIGS. 4A-B illustrate a table for data center analysis.

FIG. 5 illustrates a table for translating an overall data center rating to businesses management areas.

Like reference symbols in the various drawings indicate like elements.

### DETAILED DESCRIPTION

Data center analysis includes analyzing a data center based on the maturity of its physical infrastructure, information technology environment, systems management, operational infrastructure, application infrastructure, application development, and globalization, where maturity reflects the level of management organization of each category. Such an analysis is useful for comparing data centers and determining how to improve data centers. However, data center analysis also includes analyzing a data center based on the maturity of any of its resource categories.

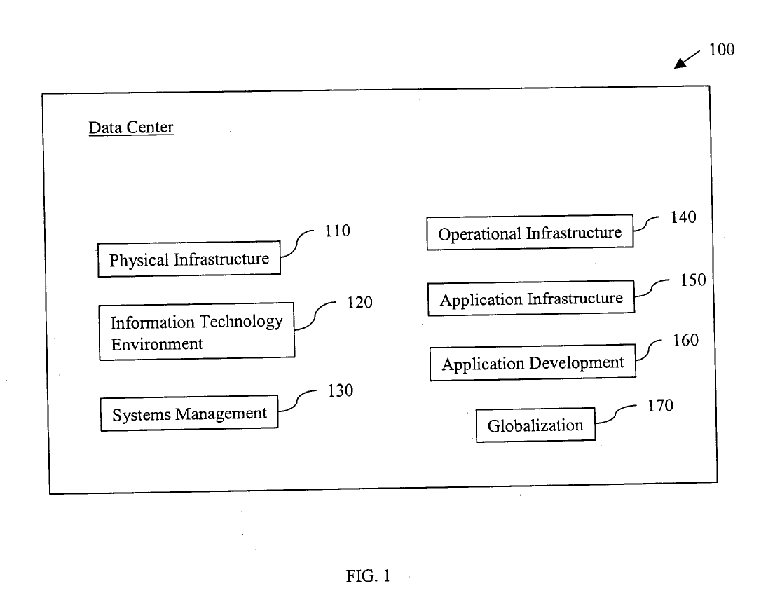

FIG. 1 illustrates a model 100 for data center analysis. Model 100 includes physical infrastructure 110, information technology environment 120, systems management 130, operational infrastructure 140, application infrastructure 150, application development 160, and globalization 170. In general, categories 110-170 are indicative of resources of a data center, and evaluating the maturity of each of these categories provides insight into the overall maturity of a data center. Other models may contain any number and/or type of resource categories.

Physical infrastructure 10 includes items related to the physical part of a data center. Thus, things such as the building, location, security, disaster recovery capability, processes, service excellence, service level management, standardization, network latency, data access latency, pre-emptive auto-recovery, and real-time data center business view may fall within this category.

In regards to the building, a key point may be whether the building is “hardened.” A hardened data center is one in which there are no single points of failure from a physical infrastructure perspective (such as power). The data center probably also needs to have backup capability for most capabilities of the data center. The rating levels for a hardened data center may range from low (processes and procedures in place to recover from failures), to medium (no single point of failure and processes in place and operational for recovery from failures), to high (no single point of failure and backup capabilities for all functions).

The physical location of a data center may be important to the overall success of the processing that takes place in the data center. Careful planning needs to occur in the selection process for the data center location, including, but not limited to, availability of power, people, resources, network connectivity, and infrastructure availability. The rating levels for data center location may range from low (no planning for the data center placement and location), to medium (some planning for the data center placement and location), to high (all planning performed and documented for the data center placement and location).

For security, a data center may need to have fully secured access to a raised floor for authorized personnel only. The rating levels for security may range from low (no security in place for raised floor access), to medium (secured for raised floor access), to high (triple authentication for raised floor access).

For disaster recovery capability, a disaster recovery plan on a site-level may need to be in place. Note that this does not necessarily imply that applications are included in the disaster recovery plan, although they could be. The rating levels for disaster recovery capability may range from low (disaster recovery plan in place), to medium (disaster recovery plan in place and tested), to high (disaster recovery plan in place and tested on a regular basis, at least annually).

Processes may include fully documenting processes such that the infrastructure components are described. The rating levels for processes may range from low (minimal processes in place and followed), to medium (processes in place and followed with deviations at times), to high (all processes followed all the time, with deviations documented and approved through problem and change management process).

Service excellence may include the ability to actively monitor, possibly on a near-real-time basis, the health of the overall business environment, the service provided, and the client's perception of the service provided. The rating levels for service excellence may range from low (manual update processes in place), to medium (fully automated processes in place), to high (fully automated processes and a customizable dashboard in place).

Service level management may include the ability to monitor and report the health of system-level and business-level metrics. This may include the ability to track service levels at the business level, since that is a key component to clients. The rating levels for service level management may range from low (system-level service levels in place), to medium (system-level service levels in place and processes in place to actively and pro-actively monitor and manage exceptions), to high (system-level and business-level service levels in place and processes in place to actively and pro-actively monitor and manage exceptions).

Standardization may include ensuring that all processes that are executed in support of the data center are standardized across the whole organization. Standardization may lead to decreased time-to-market for truly innovative ideas, as the idea-to-reality cycle is reduced through the deployment of a standard toolset and technology currency. The rating levels for standardization may range from low (processes in place), to medium (processes in place and followed), to high (whole organization is ISO certified).

Network latency may include the latency in accessing data across a network, which is a key area of concern for most data centers. The data may be located inside the organization's firewall or outside. Thus, network latency may be an internal issue as well as an external issue. The rating levels for network latency may range from low (noticeable network delays for internal and external data access), to medium (occasional network delays for internal and external data access during peak periods), to high (no network latency contributes to data access delays).

Data access latency is also important because it may result in transaction slowdown and negative business impact. Items that may affect data access include servers, storage, memory, and connectivity, which may be associated with a Storage Area Network (SAN). The rating levels for data access latency may range from low (performance reports show that data access latency is a major contributing factor impacting business functions), to medium (performance reports show that data access latency is a contributing factor impacting business functions), to high (no data access latency issues impact business).

Preemptive auto-recovery may include having plans to address problems that tend to have repeatability. These plans may have predetermined decision-making ability to start, recover, and restart a process or system based on rules. The rating levels for preemptive auto-recovery may range from low (auto-recovery plans are manual processes based on process enhancement), to medium (auto-recovery is performed based on business rules for acceptable Service Level Agreement (SLA) guidelines automatically), to high (auto-recovery has executive support for immediate action for problem avoidance, system recovery, and batch support).

A real-time data center business view may include having all information related to the health of the data center available in a real-time mode. This implies that data can be displayed real-time, and that there is a drill-down mechanism for problems that arise. The rating levels for real-time business view may range from low (little to no monitoring is performed for data center critical components), to medium (more than half of all components are monitored in real-time and with drill-down capability), to high (all data center critical systems are monitored in real-time and with drill down capability and automated escalation procedures in place).

Information technology environment 120 relates to technology deployment and the strategy for refreshing the deployed hardware and software technologies. Information technology management 120 may include having a technology refresh process, implementing a technology refresh, having tactical and strategic planning, having a real-time client business view, and having a virtual data center.

A technology refresh process relates to refreshing the existing infrastructure to allow for the introduction and exploitation of new technology that improves availability and manageability. The rating levels for a technology refresh process may range from low (no technology refresh plan in place), to medium (a fully documented technology refresh plan is in place and updated regularly), to high (a fully documented technology refresh plan is in place, updated, and used on an ongoing basis).

Technology refresh implementation relates to the ability of the organization to implement its technology refresh process. The rating levels for technology refresh implementation may range from low (no planned technology refresh implementation performed), to medium (a fully documented technology refresh implementation plan is in place and executed regularly), to high (a fully documented technology refresh implementation plan is in place, updated on an ongoing basis, and executed as part of the infrastructure processes).

Tactical and strategic planning relate to the ability to create and execute tactical and/or strategic infrastructure plans. This may be a key indicator of maturity of a data center. The rating levels for tactical and strategic planning may range from low (no tactical or strategic planning), to medium (either tactical or strategic planning performed and executed), to high (tactical and strategic planning performed and executed).

A client may need to have visibility into both the technology components and the business view of the deployed technology. Thus, having a real-time client business view may be important. In such a view, the client may be presented with a customizable business view of the underlying information technology components based on the business view that is required. The rating levels for real-time client business view may range from low (no client business view), to medium (manual process to create business process with extensive delay), to high (real-time view of all business processes).

A current trend in the compute arena is compute virtualization, specifically grid computing. Grid computing is defined as the ability to locate, request, and use computing, network, storage, and application resources and services to form a virtual IT infrastructure for a particular function, and then to release these resource and services for other uses upon completion. This may enable utility computing, which typically consists of a set of services and standardized network, server, and storage features in a shared infrastructure that service multiple clients across multiple locations. As such, utility computing is a network-delivered technology that may be provisioned and billed primarily on a metered basis. The rating levels for virtual data center may range from low (no strategy in place for virtualization), to medium (initial stages for grid and utility computing in place), to high (full-blown roll-out and deployment of grid and utility computing across the enterprise).

Systems management 130 relates to the management of hardware and software, and is an important area for many data centers. Effective management of installed hardware and software will enable a data center to provide highly reliable service, possibly in the five nines arena (99.999% availability). Systems management 130 may include performance management, capacity planning, dynamic resource allocation, single consolidated consoles, and IT processes.

Performance management relates to managing the performance of the systems running in the data center from a day-to-day management perspective. Performance management may be important to the health of not just the individual system, but to the operation of all systems in the data center, as a problem in one system can proliferate to all systems in the data center (and the enterprise) as a results of interconnectivity between the systems. The rating levels for performance management may range from low (performance management implemented at the technical level, and monitoring performed on an exception basis), to medium (performance management implemented at the technical level, and monitoring performed on a pro-active basis), to high (performance management implemented at the technical and business level, and monitoring performed on a pro-active basis).

Capacity planning relates to planning for growth. Capacity planning may include planning for organic and non-organic growth from a technical (actual usage) and a business perspective. The rating levels for capacity planning may range from low (capacity plan in place based on history), to medium (capacity plan based on history and new functions and features), to high (capacity plan in place based on actual usage and business trends).

Dynamic resource allocation involves deploying self-managing systems (possibly a combination of hardware and software). The components of dynamic resource allocation may include self-optimizing, self-configuring, self-healing, and self-protecting systems. This concept may be similar to IBM's Autonomic Computing initiative. The rating levels for dynamic resource allocation may range from low (some manual resource allocation across selected systems), to medium (some compatible systems within the data center are linked and allow for manual resource allocation across the linked systems), to high (all compatible systems within the data center are linked and allow for automated and dynamic resource allocation across the linked systems).

Consoles are typically used to manage a data center's systems, and management of the individual systems is important to the overall smoothness of operations. The more tightly integrated the consoles of the different systems are, the more visibility there is into the different areas. At the same time, integration of the consoles allows for drill-down in case of problems. Thus, having a single, consolidated console may be important. The rating levels for a single, consolidated console may range from low (some components within systems have integrated and consolidated consoles), to medium (some mission critical systems have consolidated consoles and drill-down capability for all major mission critical applications), to high (all mission critical systems have consolidated consoles and drill-down capability for all major mission critical applications).

IT processes relates to the operation of the IT organization. The rating levels for IT processes may range from low (repeatable and standardized processes), to medium (managed processes that are measured on an ongoing basis), to high (change processes to increase quality and performance).

Operational infrastructure 140 is typically a key area in a data center in which people are still needed for many direct interactions with the systems. As such, these interactions may lead to outages due to mishandling or errors. Through the use of technology, processes, and procedures, these outages may be managed and avoided in most instances. Operational infrastructure 140 may include standardization, business continuity, problem and change management, root cause analysis, and lights-out operation.

For standardization, hardware and software selections need to be standardized. The rating levels for standardization may range from low (no standards in place), to medium (standards in place but not always followed), to high (standards in place and enforced through committee).

Business continuity involves enhancements to disaster recovery to include recoverability to major business processes. The rating levels for business continuity may range from low (business continuity plans in place), to medium (static business continuity plans in place and tested), to high (active business continuity plans in place and tested on a regular basis, at least annually, to mitigate the potential of an outage).

Problem and change management relates to having a documented and integrated problem and change management process. The rating levels for problem and change management may range from low (paper-based problem and change management system without centralized tracking), to medium (electronic problem and change management system with automated approval process), to high (fully electronic, documented, and integrated problem and change management process in place and enforced).

A root cause analysis program may avoid any duplication of outages. The rating levels for root cause analysis may range from low (root cause analysis program in place but not always executed), to medium (root cause analysis program in place and executed, but not all problems get to the root cause), to high (fully—executive level—enforced root analysis program with all problems entering the program having the root cause determined).

In regards to lights-out operation, the ability to remotely manage dim data centers is key to leveraging the standards already in place. Separation of the equipment that must be attended from the “set-it-forget-it” type equipment saves costs and leverages operational staff. The rating levels for dim data centers range from low (identify personnel requirements for facility and raised floor equipment), to medium (move equipment that is not personnel-intensive into a separate facility, turn out the lights, and manage with small number of staff), to high (move equipment that is not personnel-intensive to a separate, less expensive facility, manage remotely, and turn out the lights).

Application infrastructure 150 relates to the structure and performance of the applications used by the date center, and may be a key component to the overall capability of a data center to provide service. A data center can only deliver availability as high as the application was designed for; if an application is not designed for high-availability, a data center will be unable to deliver high availability through the deployment of infrastructure hardware and software. Application infrastructure 150 may include high availability and virtual applications.

High availability typically implies that some sort of clustering is implemented and that the application can take advantage of the clustering upon failover, which may be automated. The rating levels for high availability for an application range from low (no high availability solution in place at the application infrastructure level), to medium (a clustered environment is in place with manual processes for failover), to high (a clustered environment for systems and applications is in place and automated failover scripts are implemented and tested on a quarterly basis).

Virtual applications are the next level in the virtual data center concept. Virtual applications allow for utility-type management from a data center and client perspective (including resource usage and billing). Additionally, the applications allow for pure plug-and-play, in that applications may be interchanged and may be run on any platform in the computer infrastructure. The rating levels for virtual applications may range from low (all applications are built to run on a specific hardware instance), to medium (some form of platform independence and utility-type billing and management capability is provided), to high (all applications are hardware platform and operating system agnostic and allow for utility-type billing and management).

Application development 160 involves the development of new applications for the data center. The development of new applications may be an important component of the capability of a data center to deliver quality service. As applications grow in size and more-and-more applications are interconnected, the complexity of the environment increases. As such, the application development needs to take into account standards for development (including promotion-to-production) and overall simplicity of an application. Application development 160 may include application standardization, application maturity, and application simplicity.

Application standardization relates to having a standardized software development toolset. The rating levels for standardization may range from low (no standards in place), to medium (standards in place but not always followed), to high (standards in place and enforced through committee).

Application maturity relates to the maturity of the software processes of an organization. The Capability Maturity Model (CMM) may be a good way to measure application maturity. The rating levels for application maturity may range from low (CMM level 1 and 2), to medium (CMM level 3), to high (CMM level 4and 5).

The levels of standardization of applications and application integration may be crucial to a data center and its operation. The level of application consolidation, or “application simplicity,” is a measurement of the simplicity of the application set. The rating levels for application simplicity may range from low (more than 7,500 applications), to medium (more than 1,500, but less than 7,500 applications), to high (less than 1,500 applications).

As data centers proliferate across the globe, internationalization issues (such as language and data retention) become part of the daily complexity of issues that need to be addressed. At the same time, workload management across the globe becomes more prevalent, requiring the deployment of global processes and procedures. Globalization 170 may include geographic diversity, workload characterization, global standardization, and global processes.

Geographic diversity relates to the location of data centers. The geographical location of data centers may be important from business continuity and risk mitigation perspectives. The level of implementation and deployment in the geographic diversity is a measurement of the maturity of a data center. The rating levels for geographic diversity may range from low (no planned geographical diversity), to medium (planned and initial stage of implementation of geographic diversity), to high (planned, implemented, and exploitation of geographic diversity).

The characterization of workload (into categories like mission critical, business impacting, and no impact) may be important to the overall management of data center resources such as backup, recovery sequencing, and resource allocation. The rating levels for workload characterization may range from low (a classification system is in place but classification is not enforced), to medium (the majority of the systems have been classified and classification is enforced), to high (all systems within the data centers are classified and classification is enforced).

Global standardization relates to having process and technology standards in place and enforced on a global basis. The rating levels for global standardization may range from low (global processes and technologies are defined but not enforced globally), to medium (major processes and technologies are standardized and enforced globally), to high (all processes and technologies are standardized and enforced globally).

Once data centers become globally dispersed, it may be important that the workload can be managed globally, regardless of the location. In order to effectively manage these global data centers, processes need to be put in place that allow for a seamless integration of the different locations. The rating levels for global processes may range from low (no global processes in place, only local processes and procedures), to medium (some processes are globalized, and some are localized), to high (all processes are globalized, with some local extensions and enhancements, and globalization is enforced through the use of a quality system).

Using model 100, a data center analysis may be performed by determining a rating for the maturity of the data center in one or more of categories 110-170. Maturity is an indication of the management organization of a category. The rating for each category may use any appropriate scale, such as, for example, 0-5, 1-100, or A-F.

Table 1, for example, illustrates a six-level maturity rating scheme. In this scheme, each of the components is rated 0-5, with 0 indicating that the function is not performed at all, and 5 indicating that the function is performed at the top level. Furthermore, each of the ratings has a specific description that outlines the requirements for obtaining that rating. By outlining the requirements for a rating, subjectivity is removed, at least in part, from the analysis. Other schemes could have less or more levels, or a different definition of levels.

TABLE 1

| | Maturity | |
|---|---|---|
| Range | Level | High-Level Description |
| 0.01-1.00 | Initial | Local ownership, departmental focus, |
| | | no standards, prone to failure, |
| | | inconsistent solutions |
| 1.01-2.00 | Stable | Current environment frozen, documented |
| | | processes, reduced downtime |
| 2.01-3.00 | Consistent | Standards and procedures implemented, |
| | | data sharing beginning, measurements |
| | | established, vision enabled |
| 3.01-4.00 | Leveraged | Enterprising the consistent environment, |
| | | organizational data sharing |
| 4.01-5.00 | Optimized | Highly automated, intelligent |
| | | information systems, flexible, |
| | | responsive leveraged environment |

In determining maturity, each of categories 110-170 may be analyzed based, for example, on the components discussed above. Each of the components may be given a maturity rating, and then an average rating for the components of the category may be computed to determine a rating for the category. An average of the ratings for the categories may be computed to determine an overall rating for the data center.

The overall rating may be compared to a standard, like the one in Table 1, for example, to determine where the data center rates relative to overall maturity. Additionally, the rating may be used to map the data center qualities to business management areas, as discussed below. Thus, business people may understand where the data center stands from a business perspective and determine where the data center needs to improve to reach the next rating level.

The model illustrated by FIG. 1 has a variety of features. For example, because the model emphasizes the management of resources, as opposed to the resources themselves, the model has less chance of becoming dated as technology changes. Moreover, any categories or components that have technical linkage may be eliminated or modified as technology changes. As another example, because each of the categories is identifiable in a data center environment, the analysis may be conducted with the assistance of the people that manage the categories, which may lead to a more accurate assessment, given the familiarity of those people with the processes. Additionally, if any categories of data center resources become particularly important, those categories may be emphasized by using a weighted average or other skewed scoring technique.

The model also focuses on effectiveness and efficiency. Thus, data centers that support business objectives, whether static or dynamic, in a timely and quality fashion and support business objectives at the lowest possible cost are, accordingly, rated higher.

The model additionally may be appropriate for ferreting out data centers that focus on the delivery of managed business services in support of business functions in a business partner relationship. In these data centers, the focus may be on the client and the delivery of service according to pre-established business-level service levels. Moreover, the client may want a real-time view into the business and information technology through a personalized dashboard that may be used to manage the client's expectations.

As a further example, the model may help to discover data centers that assist in the rapid deployment and exploitation of business functions as they relate to the organization's ability to take advantage of market opportunities, a type of data center that is valued by many. These types of data centers may be able to create virtual enterprises to rapidly fill market voids and create a competitive advantage in a manner that is not possible within a strictly hierarchical structure.

As noted above, the model allows an assessment of the management organization of data center resources, as opposed to an evaluation of the resources themselves. For example, the model may reflect the ability to manage people, technology, training, tools, processes, network, and cost. This ability may be important because people will probably remain a key component of the operation of a data center. As such, people need to have access to resources, technologies, and training. A key to an effective and efficient use of people in a data center may be through leverage, re-use, and adoption of best practices.

In regards to technology, a data center may have to deploy proven technology that is on the leading edge in order to provide a competitive advantage to the clients being served. At the same time, leading edge technologies may provide a data center with an effective and efficient way to manage the overall IT environment.

For training, two areas may be important to the day-to-day operations: people and technologies. From a people perspective, rigorous processes and procedures need to be implemented, enforced, and accompanied by adequate training. Additionally, the ever-changing technologies need to be disseminated throughout the organization in the form of training and education.

In regard to tools, the selection and implementation of tools may be important in the path of data center progression. The tools should include features such as intelligent operations, exception management, automation, and outage prevention.

The implementation and enforcement of a rigorous set of processes and procedures for the complete IT environment, from installation, to maintenance, to support, to problem and change management, to de-installation, is typically one of the cornerstones of a progressing data center.

The network (and the associated network latency and connectivity), especially in today's networked environment, may be important, not only in the day-to-day operations of the data center, but also in the tactical and strategic decision process for data center placement across the globe.

Finally, as in any organization, decisions are based on a cost/benefit analysis. As such, the creation of (or move towards) a better data center requires a careful analysis of the benefits derived from any investments targeted at improving the level of service provided by the data center.

Current data centers with exemplary maturity possess a variety of characteristics and technologies. Some of these include client support, logical security, physical security, disaster recovery, storage networks, network connectivity, redundant equipment, and backup solutions. The basic functionality for client support includes 7×24 client support, a single point of contact for problems and resolution, and account and project management assistance. The basic functionality for logical security includes router and firewall management, server auditing and scanning, and vulnerability assessment scanning. The basic functionality for physical security includes electronically controlled access, secure raised floor, security staff on site 7×24, fire and smoke detection and suppression, and disaster safeguards. The basic functionality for disaster recovery includes the capability to fail-over processing at alternate sites within the established business guidelines for outages. The basic functionality for storage networks includes fiber- and network-attached storage, and storage management capabilities. The basic functionality for network connectivity includes high-speed network capabilities, high-speed public Internet connectivity, and redundant network capability through diversified network providers. The basic functionality for redundant equipment includes redundant power grid connections, multiple power feeds, diesel backup, battery backup and uninterruptible power supply capability, and critical spare part strategy. The basic functionality for backup solutions includes virtual, off-site, and robotic tape solutions, and non-intrusive and non-disruptive tape backup capabilities.

Note, however, that these merely represent technologies and their potential uses in the quest for an exemplary data center. Furthermore, while the characteristics and technologies that are currently deployed in data centers with exemplary maturity levels may be well understood, the characteristics and technologies of exemplary data centers will change over time, especially as technologies become obsolete and new technologies emerge.

Although FIG. 1 illustrates a model for data center analysis, other implementations may include less, more, and/or a different priority of categories. For example, for data centers that do not need many direct interactions between people and the systems, operational infrastructure may be reduced in priority or eliminated. As another example, for data centers that have to be located in one country, for security or political reasons, globalization may be reduced in priority or eliminated.

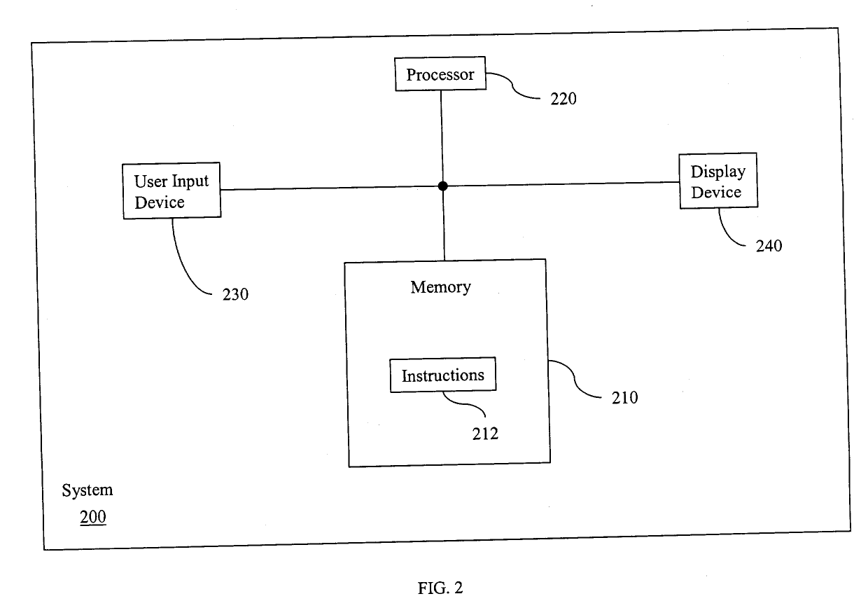

FIG. 2 illustrates a system 200 for data center analysis. System 200 includes memory 210, a processor 220, an input device 230, and a display device 240. Memory 210 contains instructions 212 and may include random access memory (RAM), read-only memory (ROM), compact-disk read-only memory (CD-ROM), registers, and/or any other appropriate volatile or non-volatile information storage device. Processor 220 may be a digital processor, an analog processor, a biological processor, an atomic processor, and/or any other type of device for manipulating information in a logical manner. Input device 230 may include a keyboard, a mouse, a trackball, a light pen, a stylus, a microphone, or any other type of device by which a user may input information to system 200. Display device 240 may be a cathode ray tube (CRT) display, a liquid crystal display (LCD), a projector, or any other appropriate device for displaying visual information.

In one mode of operation, processor 220, according to instructions 212, generates a user interface containing the resource categories of a data center and their components, and display device 240 displays the user interface. Furthermore, the user interface may contain a description outlining the requirements for obtaining particular maturity ratings.

System 200 then receives an indication of the maturity rating of the components through input device 230. The rating for each component may use any appropriate scale, such as, for example, 0-5, 1-100, or A-F.

After receiving a maturity rating for one or more components, processor 220 determines an overall rating for the data center under analysis. The overall rating may then be compared to a rating standard to determine where the data center rates relative to overall maturity. The overall rating may be compared to the rating standard in a table, graph, or other appropriate construct.

In other implementations, to be discussed below, the overall rating may be used to map the data center qualities to business management areas. Thus, business people may understand where the data center stands from a business perspective. Furthermore, the business management areas for an enhanced data center may be determined to permit business people to determine where the data center needs to improve to reach the next rating level.

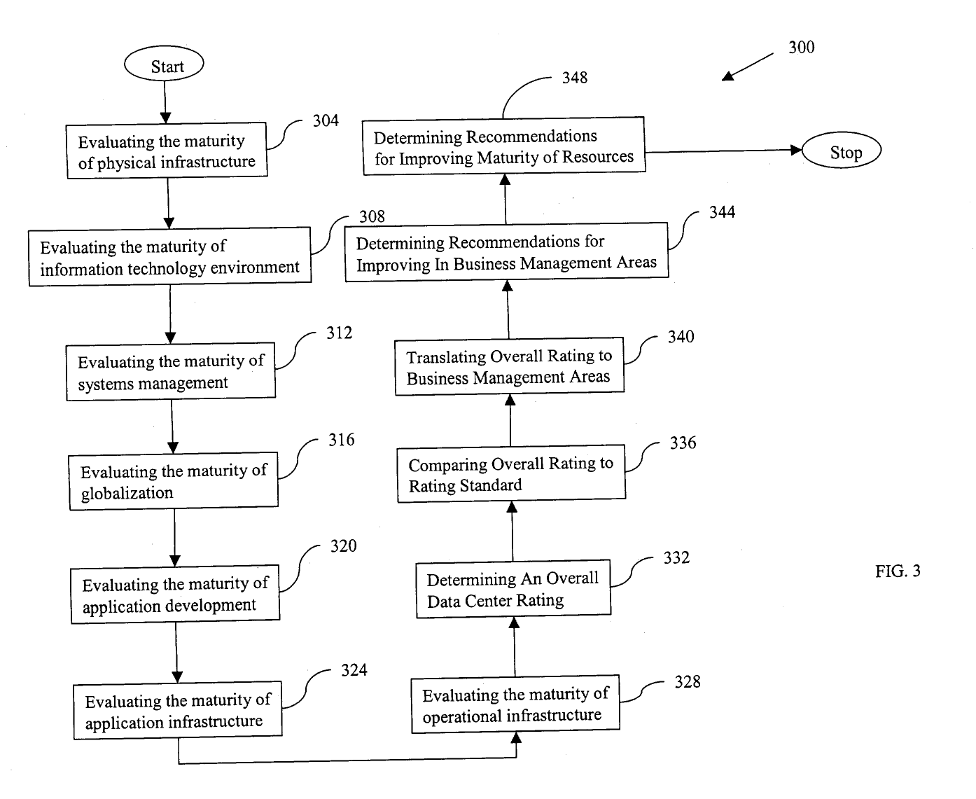

FIG. 3 is a flow chart illustrating a process 300 for data center analysis. Process 300 could describe the operations of a system similar to system 200 of FIG. 2.

The process begins with evaluating the maturity of physical infrastructure (step 304). Evaluating the maturity of physical infrastructure may include, for example, determining a maturity rating for physical infrastructure components, including, for example, building, location, security, disaster recovery capability, processes, service excellence, service level management, standardization, network latency, data access latency, pre-emptive auto-recovery, and data center status monitoring capability, and averaging the ratings for the components or just determining the maturity ratings for the components. The rating may use any appropriate scale.

The process continues with evaluating the maturity of the information technology environment (step 308). Evaluating the maturity of information technology environment may include, for example, determining a maturity rating for information technology environment components, including, for example, having a technology refresh process, implementing a technology refresh, having tactical and strategic planning, having a real-time client business view, and having a virtual data center, and averaging the ratings for the components or just determining the maturity ratings for the components.

The process next calls for evaluating the maturity of systems management (step 312). Evaluating the maturity of systems management may include, for example, determining a maturity rating for systems management components, including, for example, performance management, capacity planning, dynamic resource allocation, single consolidated consoles, and IT processes, and averaging the ratings for the components or just determining the maturity ratings for the components.

The process continues with evaluating the maturity of globalization (step 316).

Evaluating the maturity of globalization may include, for example, determining a maturity rating for globalization components, including, for example, geographic diversity, workload characterization, global standardization, and global processes, and averaging the ratings for the components or just determining the maturity ratings for the components.

The process next calls for evaluating the maturity of application development (step 320). Evaluating the maturity of application development may include, for example, determining a maturity rating for application development components, including, for example, standardization, application maturity, and application simplicity, and averaging the ratings for the components or just determining the maturity ratings for the components.

The process continues with evaluating the maturity of application infrastructure (step 324). Evaluating the maturity of application infrastructure may include, for example, determining a maturity rating for application infrastructure components, including, for example, high availability and virtual applications, and averaging the ratings for the components or just determining the maturity ratings for the components.

The process continues with evaluating the maturity of operational infrastructure (step 328). Evaluating the maturity of operational infrastructure may include, for example, determining a maturity rating for operational infrastructure components, including, for example, standardization, business continuity, problem and change management, root cause analysis, and lights-out operation, and averaging the ratings for the components or just determining the maturity ratings for the components.

The process next calls for determining an overall data center rating (step 332). Determining an overall data center rating may be accomplished, for example, by averaging ratings for physical infrastructure, information technology environment, systems management, globalization, application development, application infrastructure, and operational infrastructure; averaging ratings for components of those categories; or by any other appropriate technique. In particular implementations, a weighted average may be used if certain categories and/or components have special significance. The overall data center rating reflects how well the data center's resources are managed.

The process continues with comparing the overall rating to a rating standard (step 336). By making this comparison, a data center under evaluation may be ranked in terms of class. For example, as mentioned previously, a data center may be classified as initial, stable, consistent, leveraged, or optimized.

The process next calls for translating the overall rating to business management areas (step 340). This may be accomplished, for example, by comparing the overall rating to a table containing business management characteristics for a data center based on overall ratings. An example of such a comparison is discussed below.

The process continues with determining recommendations for improvement in business management areas for the data center under evaluation (step 344). This may be accomplished, for example, by comparing the characteristics of a higher-rated data center to the characteristics associated with the overall data center rating. By determining recommendations, business decision makers may be able to appropriately focus resources for improving the data center under evaluation.

The process next calls for determining recommendations for improving the maturity of data center resources (step 348). This may be accomplished, for example, by examining a table that contains the attributes of data centers based on overall rating or broken down by category, an example of which will be discussed below. Thus, the attributes that a data center category should have to reach the next classification level may be determined.

Although FIG. 3 illustrates one implementation of a process for data center analysis, other implementations may include fewer, more, and/or a different arrangement of operations. For example, any of steps 304-328 may be performed in any order. Additionally, step 328 may be eliminated, especially for data centers in which people are not still needed for many direct interactions with the systems. Furthermore, step 332, step 344, and step 348 may be performed in any order.

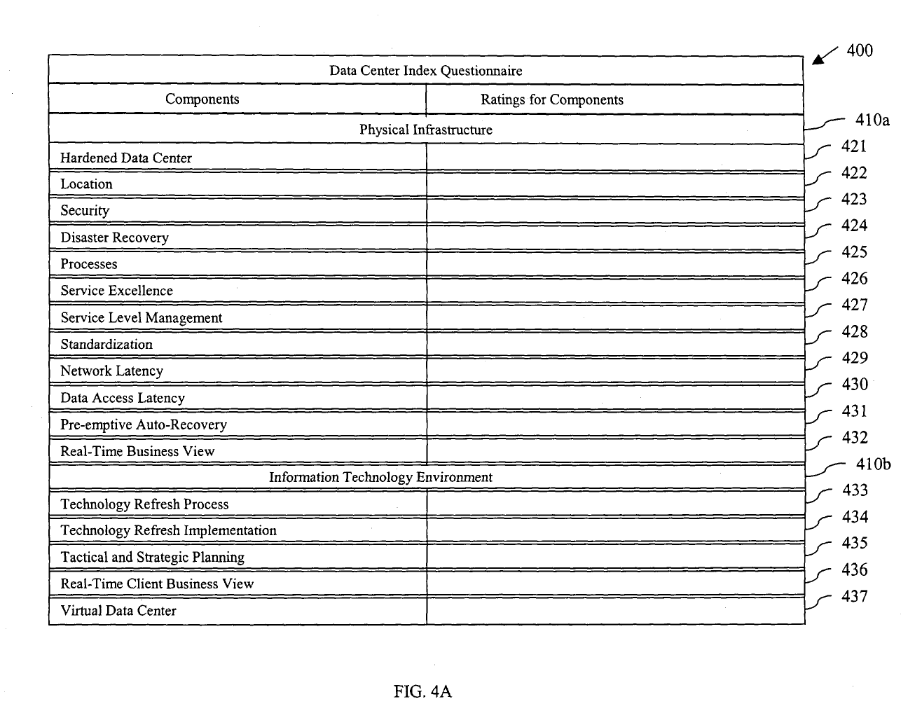

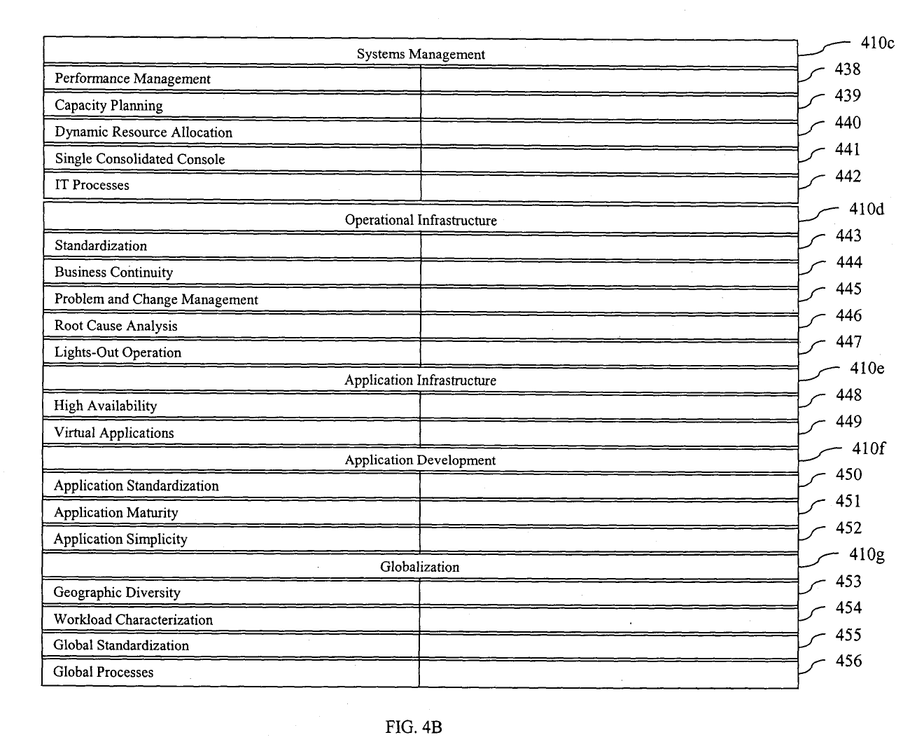

FIGS. 4A-B illustrates a table 400 for analyzing a data center. As illustrated, table 400 is subdivided into seven categories 410, each of which includes some of components 421-456.

The components of category 410a—physical—infrastructure—include hardened data center 421, location 422, security 423, disaster recovery capability 424, processes 425, service excellence 426, service level management 427, standardization 428, network latency 429, data access latency 430, pre-emptive auto-recovery 431, and real-time business view 432. Thus, category 410a may be analyzed by analyzing each of components 421-432.

The components of category 410b—information technology environment—include technology refresh process 433, technology refresh implementation 434, tactical and strategic planning 435, real-time client business view 436, and virtual data center 437. Thus, category 410b may be analyzed by analyzing each of components 433-437.

The components of category 410c—systems management—include performance management 438, capacity planning 439, dynamic resource allocation 440, single consolidated console 441, and IT processes 442. Thus, category 410c may be analyzed by analyzing each of components 438-442.

The components of category 410d—operational infrastructure—include standardization 443, business continuity 444, problem and change management 445, root cause analysis 446, and lights-out operation 447. Thus, category 410d may be analyzed by analyzing each of components 443-447.

The components of category 410e—application infrastructure—include high availability 448 and virtual applications 449. Thus, category 410e may be analyzed by analyzing each of components 448-449.

The components of category 410f—application infrastructure—include application standardization 450, application maturity 451, and application simplicity 452. Thus, category 410f may be analyzed by analyzing each of components 450-452.

The components of category 410g—application infrastructure—include geographic diversity 453, workload characterization 454, global standardization 455, and global processes 456. Thus, category 410g maybe analyzed by analyzing each of components 453-456.

Table 400 provides an easy and consistent way to assess a data center. Furthermore, table 400 may be used as a hard-copy, displayed in a user interface, or used in any other appropriate format. If presented in a user interface, a computer may be able to readily determine an overall data center rating, compare the overall rating to a rating standard, translate the overall rating to business management areas, determine recommendations for improving the data center, and/or perform any other appropriate function. In particular implementations, table 400 is part of a spreadsheet.

Having a set of evaluation criteria such as in FIGS. 4A-B allows standardization of analysis process. Thus, evaluators gain appreciation of the types of questions and issues with which they have to deal during analysis, leading to more efficient and consistent evaluations.

Although FIGS. 4A-B illustrate a table for analyzing a data center, other tables may contain more, less, and/or a different arrangement of categories and/or components. Additionally, other constructs may be used for performing or recording analysis.

In particular implementations, definitions are provided for each evaluation level for the components. Providing definitions for each level assists in removing subjectivity from the evaluation process by providing definitions for the different levels of maturity classification for each component.

Table 2 illustrates a rating system that allows for six levels of granularity in the maturity rating for each component. In general, however, the level of granularity can have any number or type of stratifications, such as, for example, 0-5, A-F, or Low-Medium-High, as long as each stratification is defined. Furthermore, each level of granularity is defined for each component.

TABLE 2

| Component | Rating Definition | |
|---|---|---|
| Hardened | 0 | No processes and procedures in place to recover from failures |
| Data Center | 1 | Some processes and procedures in place to recover from failures |
| | 2 | No single point of failure and processes in place for recovery of failures |
| | 3 | No single point of failure and processes and operational in place for |
| | | recovery of failures |
| | 4 | No single point of failure, and processes and operations in place for |
| | | recovery of failures and access to backup site |
| | 5 | No single point of failure and immediate backup capabilities for all |
| | | functions |
| Location | 0 | No planning for the data center placement and location |
| | 1 | Some planning for physical infrastructure only |
| | 2 | Some planning for the data center placement and location |
| | 3 | Some planning performed and documented for the data center placement |
| | | and location |
| | 4 | Planning performed on a case-by-case basis |
| | 5 | All planning performed and documented for the data center placement |
| | | and location |
| Security | 0 | No security in place |
| | 1 | No security in place for raised floor access |
| | 2 | Some security in place for raised floor access (card access only) |
| | 3 | Secured raised floor access (card access with PIN code) |
| | 4 | Secured raised floor access with logging of accesses |
| | 5 | Triple authentication for raised floor access |
| Disaster | 0 | No disaster recovery plans in place |
| Recovery | 1 | Disaster recovery plan in place |
| Capability | 2 | Disaster recovery plan in place and tested on paper |
| | 3 | Disaster recovery plan in place and tested |
| | 4 | Disaster recovery plan in place and tested on a regular basis |
| | 5 | Disaster recovery plan in place and tested on a regular basis, at least |
| | | annually |
| Processes | 0 | No processes in place |
| | 1 | Minimal process in place |
| | 2 | Processes in place and followed |
| | 3 | Processes in place and followed, with deviations at times |
| | 4 | Processes in place and followed, with deviations documented at all times |
| | 5 | All processes followed all the time, with deviations documented and |
| | | approved through problem and change management process |
| Service | 0 | No service excellence |
| Excellence | 1 | Manual update processes in place |
| | 2 | Mostly manual, some automated processes in place |
| | 3 | Fully automated processes in place |
| | 4 | Fully automated processes in place with non-customizable dashboard |
| | 5 | Fully automated processes in place with a customizable dashboard |
| Service Level | 0 | No service levels in place |
| Management | 1 | System-level service levels in place |
| | 2 | System-level service levels in place and processes in place to monitor |
| | | exceptions |
| | 3 | System-level service levels in place and processes in place to actively |
| | | and pro-actively monitor and manage exceptions |
| | 4 | System-level and business-level service levels in place |
| | 5 | System-level and business-level service levels in place, and processes in |
| | | place to actively and pro-actively monitor and manage exceptions |
| Standardization | 0 | No processes in place |
| | 1 | Processes in place |
| | 2 | Processes in place and followed across some organizations |
| | 3 | Processes in place and followed across all organizations |
| | 4 | Organization is working towards ISO certification |
| | 5 | Whole organization is ISO certified |
| Network | 0 | Network latency is the major cause for delays for internal and external |
| Latency | | data access |
| | 1 | Noticeable network delays for internal and external data access |
| | 2 | Infrequent network delays for internal and external data access during |
| | | peak periods |
| | 3 | Occasional network delays for internal and external data access during |
| | | peak periods |
| | 4 | Occasional network delays for internal and external data access |
| | 5 | No network latency contributes to data access delays |
| Data Access | 0 | Performance reports show that data access latency is the major |
| Latency | | contributing factor impacting business functions |
| | 1 | Performance reports show that data access latency is a major |
| | | contributing factor impacting business functions |
| | 2 | Performance reports show that data access latency is a contributing |
| | | factor impacting business functions |
| | 3 | Performance reports show that data access latency is a minor |
| | | contributing factor impacting business functions |
| | 4 | Performance reports show that data access latency is occasionally a |
| | | minor contributing factor impacting business functions |
| | 5 | No data access latency issues impact business |
| Pre-emptive | 0 | No auto recovery plans in place |
| Auto-Recovery | 1 | Auto-recovery plans are manual processes based on process |
| | | enhancement |
| | 2 | Auto-recovery is performed automatically for technical issues only |
| | 3 | Auto-recovery is performed based on business rules for acceptable |
| | | Service Level Agreement (SLA) guidelines automatically |
| | 4 | Auto-recovery is preformed and executed as part of the day-to-day |
| | | processes |
| | 5 | Auto-recovery has executive support for immediate action for problem |
| | | avoidance, system recovery, and batch support |
| Real-Time | 0 | No monitoring is performed for data center critical components |
| Business View | 1 | Little to no monitoring is performed for data center critical components |
| | 2 | Monitoring is performed for data center critical components |
| | 3 | More than half of all components are monitored in real-time mode with |
| | | drill-down capability |
| | 4 | All data center critical systems are monitored in real-time with some |
| | | drill down capability |
| | 5 | All data center critical systems are monitored in real-time with drill |
| | | down capability and automated escalation procedures in place |
| Technology | 0 | No technology refresh plan in place |
| Refresh Process | 1 | Technology refresh plan in place for specific technologies |
| | 2 | A fully documented technology refresh plan is in place |
| | 3 | A fully documented technology refresh plan is in place, and updated |
| | | regularly |
| | 4 | A fully documented technology refresh plan is in place, updated on an |
| | | ongoing basis |
| | 5 | A fully documented technology refresh plan is in place, updated, and |
| | | used on an ongoing basis |
| Technology | 0 | No planned technology refresh implementation performed |
| Refresh | 1 | Technology refresh implementation followed at lease-end or end-of-life |
| Implementation | 2 | A fully documented technology refresh implementation followed at |
| | | lease-end or end-of-life |
| | 3 | A fully documented technology refresh implementation plan is in place, |
| | | and executed regularly |
| | 4 | A fully documented technology refresh implementation plan is in place, |
| | | and executed quarterly |
| | 5 | A fully documented technology refresh implementation plan is in place, |
| | | updated on an ongoing basis, and executed as part of the infrastructure |
| | | processes |
| Tactical and | 0 | No tactical or strategic planning performed |
| Strategic | 1 | Tactical planning performed |
| Planning | 2 | Tactical planning performed and executed |
| | 3 | Strategic planning performed |
| | 4 | Strategic planning performed and executed |
| | 5 | Strategic and tactical planning performed and executed |
| Real-Time | 0 | No client business view |
| Client | 1 | Manual process in place for a single critical business process |
| Business | 2 | Manual processes in place for some of the critical business processes |
| View | 3 | Manual processes in place for all of the critical business processes |
| | 4 | Delayed automated processes in place for client business process views |
| | | for most business processes |
| | 5 | Real-time (automated) processes in place for client business process |
| | | views for all business processes |
| Virtual Data | 0 | No strategy in place for virtualization |
| Center | 1 | Initial work performed on virtualization, including grid computing or |
| | | utility computing |
| | 2 | Hands-on evaluations of virtualization technologies in progress or |
| | | performed |
| | 3 | Initial implementations of grid computing and utility computing in place |
| | 4 | One of major customers running in virtual data center environment |
| | 5 | Full-blown roll-out and deployment of grid and utility computing across |
| | | the enterprise |
| Performance | 0 | No performance management |
| Management | 1 | Performance management implemented at the technical level, and |
| | | monitoring performed on an exception basis |
| | 2 | Performance management implemented at the technical and business |
| | | level, and monitoring performed on an exception basis |
| | 3 | Performance management implemented at the technical level, and |
| | | monitoring performed on a pro-active basis |
| | 4 | Performance management implemented at the business level, and |
| | | monitoring performed on a pro-active basis |
| | 5 | Performance management implemented at the technical and business |
| | | level, and monitoring performed on a pro-active basis |
| Capacity | 0 | No capacity planning |
| Planning | 1 | Capacity plan in place based on history |
| | 2 | Capacity plan in place based on history and new features |
| | 3 | Capacity plan based on history and new functions and features |
| | 4 | Capacity plan based on history, new functions and features, and major |
| | | product upgrades |
| | 5 | Capacity plan in place based on actual usage and business trends |
| Dynamic | 0 | No resource allocation across systems |
| Resource | 1 | Some manual resource allocation within selected systems |
| Allocation | 2 | Some manual resource allocation across selected systems |
| | 3 | Some compatible systems within the data center are linked and allow for |
| | | manual resource allocation across the linked systems |
| | 4 | Most compatible systems within the data center are linked and allow for |
| | | automated resource allocation across the linked systems |
| | 5 | All compatible systems within the data center are linked and allow for |
| | | automated and dynamic resource allocation across the linked systems |
| Single | 0 | No console consolidation |
| Consolidated | 1 | Some components within systems have integrated and consolidated |
| Console | | consoles |
| | 2 | Some mission critical systems have consolidated consoles |
| | 3 | Some mission critical systems have consolidated consoles and drill- |
| | | down capability for all major mission critical applications |
| | 4 | Most mission critical systems have consolidated consoles and drill-down |
| | | capability for all major mission critical applications |
| | 5 | All mission critical systems have consolidated consoles and drill-down |
| | | capability for all major mission critical applications |
| IT Processes | 0 | No repeatable and standardized processes |
| | 1 | Repeatable and standardized processes |
| | 2 | Repeatable and standardized processes that are updated on an as-needed |
| | | basis |
| | 3 | Managed processes that are measured on an ongoing basis |
| | 4 | Managed processes that are measured and updated on an as-needed basis |
| | 5 | Change processes to increase quality and performance |
| Standardization | 0 | No standards in place |
| | 1 | Some standards in place |
| | 2 | Standards in place but not followed |
| | 3 | Standards in place but not always followed |
| | 4 | Standards in place and enforced by lower level management |
| | 5 | Standards in place and enforced through committee |
| Business | 0 | No business continuity plans in place |
| Continuity | 1 | Business continuity plans in place |
| | 2 | Business continuity plans in place and updated occasionally |
| | 3 | Static business continuity plans in place and tested |
| | 4 | Active business continuity plans in place |
| | 5 | Active business continuity plans in place and tested on a regular basis (at |
| | | least annually) to mitigate the potential of an outage |
| Problem and | 0 | No problem or change management process in place |
| Change | 1 | Paper-based problem and change management system without |
| Management | | centralized tracking |
| | 2 | Electronic problem and change management system with manual |
| | | approval process |
| | 3 | Electronic problem and change management system with automated |
| | | approval process |
| | 4 | Fully electronic, documented, and integrated problem and change |
| | | management process in place |
| | 5 | Fully electronic, documented, and integrated problem and change |
| | | management process in place and enforced |
| Root Cause | 0 | No root cause analysis program in place |
| Analysis | 1 | Root cause analysis program in place but not always executed |
| | 2 | Root cause analysis program in place and executed for all severity 1 and |
| | | 2 problems |
| | 3 | Root cause analysis program but not all problems get to the root cause |
| | 4 | Executive level support for root cause analysis program |
| | 5 | Fully-executive level-enforced root analysis program with all |
| | | problems entering the program having the root cause determined |
| Lights-Out | 0 | Labor-intensive and manual processes are prevalent |
| Operation | 1 | Identify personnel requirements for facility and raised floor equipment |
| | 2 | Plans in place for move of non- personnel intensive equipment into |
| | | separate facility |
| | 3 | Move non- personnel intensive equipment into a separate facility, turn |
| | | out the lights, and manage with small number of staff |
| | 4 | Full plan in place with management buy-in and tools selected and |
| | | implemented for lights-out operation |
| | 5 | Move non- personnel intensive type equipment to a separate less |
| | | expensive facility, manage remotely, and turn out the lights |
| High | 0 | No high availability solution in place at the application infrastructure |
| Availability | | level |
| | 1 | Manual processes and procedures are in place for application high |
| | | availability |
| | 2 | Manual processes and procedures and standby alternate systems are |
| | | available |
| | 3 | A clustered environment is in place with manual processes for failover |
| | 4 | A clustered environment is in place with automated processes for |
| | | failover |
| | 5 | A clustered environment for system and application and automated |
| | | failover scripts are implemented and tested on a quarterly basis |
| Virtual | 0 | All applications are built to run on a specific hardware instance |
| Applications | 1 | Some applications are platform and operating system agnostic |
| | 2 | Most applications have utility-type functions and features activated and |
| | | deployed |
| | 3 | Most applications are platform agnostic and have some type of utility- |
| | | type billing and management capability |
| | 4 | Most applications are platform agnostic and have initial implementation |
| | | of utility-type billing and management capability |
| | 5 | All applications are hardware platform and operating system agnostic |
| | | and allow for utility-type billing and management |
| Application | 0 | No standards in place |
| Standardization | 1 | Some standards are defined but not followed |
| | 2 | Some standards are defined and some are enforced |
| | 3 | Standards in place but not always followed |
| | 4 | Standards in place and enforced through peer pressure |
| | 5 | Standards in place and enforced through committee |
| Application | 0 | No CMM Level |
| Maturity | 1 | CMM Level 1 |
| | 2 | CMM Level 2 |
| | 3 | CMM Level 3 |
| | 4 | CMM Level 4 |
| | 5 | CMM Level 5 |
| Application | 0 | More than 100,000 applications |
| “Simplicity” | 1 | More than 75,00 applications, but less than 100,000 |
| | 2 | More than 50,000 applications, but less than 75,000 |
| | 3 | More than 25,000 applications, but less than 50,000 |
| | 4 | More than 15,000 applications, but less than 25,000 |
| | 5 | Less than 15,000 applications |
| Geographic | 0 | No planned geographical diversity |
| Diversity | 1 | Initial stage of geographic diversity |
| | 2 | Initial stage and roll-out of geographic diversity |
| | 3 | Planned and initial stage of implementation of geographic diversity |
| | 4 | Planned and implemented geographic diversity |
| | 5 | Planned, implemented, and exploitation of geographic diversity |
| Workload | 0 | No (workload) classification is in place |
| Characterization | 1 | A classification system is in place, but classification is not enforced |
| | 2 | A classification system is in place, and classification is enforced in some |
| | | instances |
| | 3 | The majority of the systems have been classified, and classification is |
| | | enforced |
| | 4 | All systems within the data centers are classified, and for the majority, |
| | | classification is enforced |
| | 5 | All systems within the data centers are classified, and classification is |
| | | enforced |
| Global | 0 | No global processes in place |
| Standardization | 1 | Global processes and technologies are defined but not enforced globally |
| | 2 | Global processes and technologies are defined and some are enforced |
| | | globally |
| | 3 | Major processes and technologies are standardized and enforced |
| | | globally |
| | 4 | All processes and technologies that are major ones are standardized and |
| | | enforced globally |
| | 5 | All processes and technologies are standardized and enforced globally |
| Global | 0 | No global and no local processes in place |
| Processes | 1 | No global processes in place, only local processes and procedures |
| | 2 | No global processes are globalized and all processes are localized |
| | 3 | Some processes are globalized, and all processes are localized |
| | 4 | All processes are globalized, with some local extensions and |
| | | enhancements, but no enforcement in place |
| | 5 | All processes are globalized, with some local extensions and |
| | | enhancements, and are enforced for use through the use of a quality |
| | | system |

The definitions in Table 2 could be provided to an evaluator in hard-copy or electronic format. In particular implementations, the definitions are associated with the ratings in a user interface. Thus, an evaluator can readily understand which rating a component should receive, which reduces ambiguity in the rating process. In certain implementations, the definitions are in pull-down menus for each component.

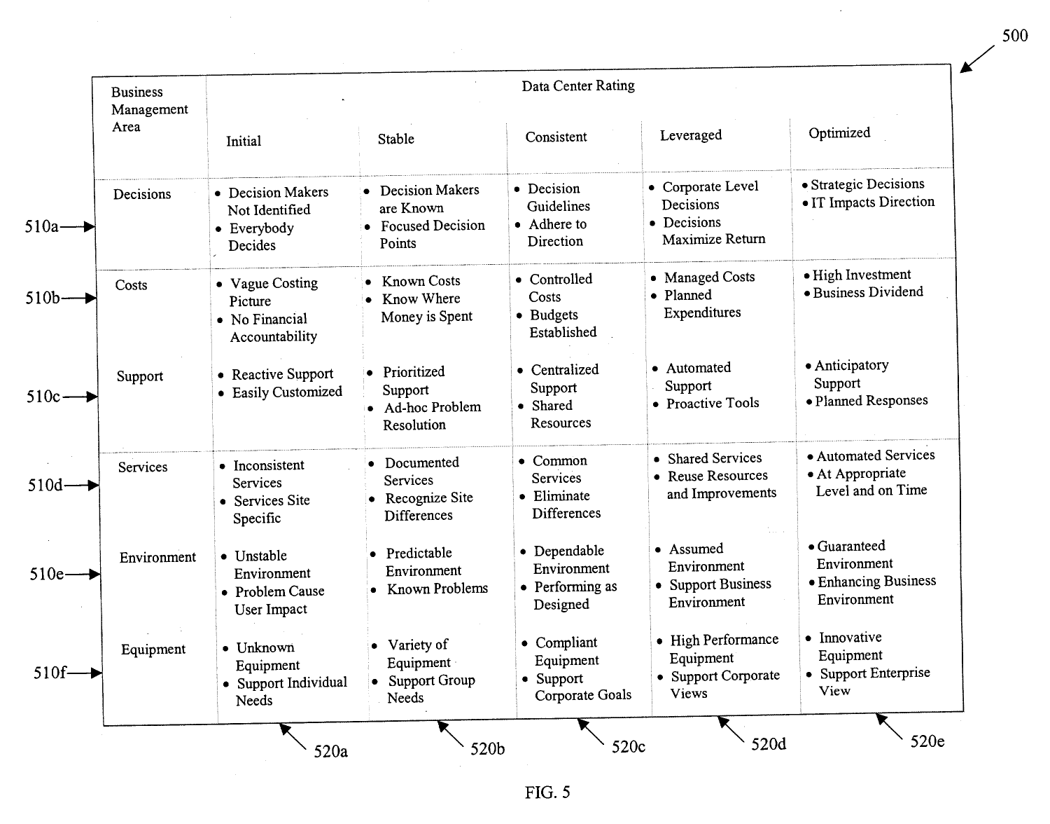

FIG. 5 illustrates a table 500 for translating an overall data center rating into business management terminology. As illustrated, table 500 includes rows 510 that specify business management categories for a data center, and columns 520 that correspond to an overall data center rating. Thus, by examining table 500 after determining an overall rating, the current status of a data center may be understood, and the improvements in order to achieve a higher rating may be determined.

Column 520a reflects the attributes of a data center having the lowest maturity rating, and generally corresponds to a relatively large number of installations. Such data centers typically have people and organizations that do not want to let go of local control. Overall, the needs of one person or organization outweigh the needs of the company, and in this type of environment, people will do what they have to in order to keep the status quo.

The attributes associated with rows 510 for a data center in the initial stage of maturity typically reflect a highly compartmentalized approach to the data center. For example, decisions reflected in row 510a typically involve unidentified decision makers. In fact, in many instances, everybody is a decision maker, resulting in a very immature organization and the creation of silos.

For costs, reflected in row 510b, only a vague cost picture is typically available, possibly due to the fact that everybody is a decision maker. At the same time, financial accountability may not exist, possibly because decisions and purchases are not consolidated through a central organization.

Support, reflected in row 510c, is typically very reactive in nature. Since decisions are made at the extreme local level, purchases and support can be easily customized for the organization, resulting in a quick time-to-market at the expense of very little corporate visibility and integration.

Services, reflected in row 510d, typically follow the support structure, in that the support services are inconsistent and extremely site specific.

Environment, reflected in row 510e, is typically not integrated, because everybody is a decision maker. This often results in a sub-optimized infrastructure, leading to an unstable overall environment. Furthermore, as a result of this lack of integration, problems occur frequently. Taking into account reactive support, the user impact may be significant, resulting in users being required to leave work due to the unavailability of the IT environment.

Equipment, reflected in row 510f, is usually unknown since there is no corporate visibility into the purchasing of the department. In fact, the equipment may be purchased with the sole purpose to support the individual needs of the organization.

A “stable” data center may have the attributes shown in column 520b. A stable data center is the foundational milestone towards maturity. This level mainly organizes the IT organization, focuses on the understanding of the current situation, and works towards elimination of making unauthorized or unapproved changes. In this phase, the environment is frozen and controls are put in place on how to change the environment.

In this level of maturity, the main focus is not on the reduction of budgets. Rather, the focus is on understanding where money is spent and establishing the decision makers. For decisions at this level, the IT decision makers are known. However, the focus of these decision makers is very local in nature, resulting in very focused decision points and associated sub-optimization.

The costs of the overall IT environment are known, even though decisions are made in a distributed fashion. More importantly, it is known where the money is spent from an IT perspective. The great unknown at this time is the business value derived from these investments.

For support, the support structure is very local in nature and support is prioritized as part of the overall work to be performed. Very little is done to perform proactive management of the environment, rather such management is based on ad-hoc problem resolution. Services, IT, and to some extent business are defined and distributed throughout the organization. Through this communication, the different organizations recognize the site differences (in light of the fact that decisions are made locally in support of the unit's requirements).

The IT environment is very predictable from a performance, capacity, and problem perspective. It is known where potential bottlenecks and problems can occur. Although this implies that the environment is moving towards a consistent environment, the environment is far from being able to support business functions.

In regards to equipment, because decisions are made at the local level, equipment purchases are done at the local level, resulting in a variety of equipment that needs to be integrated and supported. Although this variety of equipment supports the groups'needs, sub-optimization occurs, which results in non-leveraged IT expenditures.

Once the foundational step is in place (costs and decision makers are understood), the next step is focused on achieving and establishing control of the environment. In the “consistent” level of maturity, direction is set, and the authorized and empowered decision makers adhere to the direction. Since the budgets are now in place to control where the money is spent, the IT environment is performing as it was designed to perform, with no surprises.

A consistent data center may have the attributes shown in column 520c. Decisions are no longer made at the local level; rather, specific corporate guidelines for decisions are documented, implemented, and enforced. The adherence to the corporate IT direction may be important in the standardization activities. As decisions become more centralized, costs can be controlled more effectively. At the same time, budgets are established and adhered to at the local and corporate level, as IT functions start to support and enhance business functions. For this level, the IT support has moved from a local structure to a centralized support structure. This sets the stage for shared resources and common services, which are at the functional level.

As standardization moves throughout the organization, common services become more prevalent. These common services, which are the first stage towards sharing of resources and services across organization, start to eliminate differences and permit a start in viewing the business services from a corporate level. The environment is very dependable and performs as designed within the standards and guidelines set by the IT department. However, these standards and guidelines are purely IT based, with little or no focus on the underlying business functions and goals. As standards emerge, the equipment adheres to these standards in support of the corporate goals for IT.

As a next step from the consistent platform, some more complex decisions may be made. The objectives of these decisions need to focus on a single set of objectives for the complete IT environment. This is a “leveraged” data center.

A leveraged data center may have the attributes shown in column 520d. The IT decisions are made at the corporate level. Moreover, the focus of the decisions is mainly on the maximization of returns, and less on a corporate IT strategy. The costs are managed effectively during this phase. However, they are managed as costs, and not as investments in the corporation in support of the overall business strategy. During this phase, proactive monitoring and management tools come into play. The first stages of the business uses of automation are deployed, including automated support and proactive management of IT resources in support of business functions. The common services have moved up in the level of maturity to the shared services, where business units that share the same business function share the same IT service in support of that business function. This implies a great degree of cooperation among the business units (an indication of the level of maturity of an organization) as well as a tight integration of the IT services with the business functions. At this phase of maturity, the IT environment is assumed to always be there. It provides a high level of support for the business environment, and, as such, the capabilities and high availability of the equipment have become a business requirement. The deployed equipment has passed the stages of functionality and moved into the realm of high performance. Because the environment is assumed to always be there when needed, performance and reliability are required to support the corporate views of IT as a business driver.

At the final maturity level, the IT environment enhances, complements, supports, and drives the strategic direction and strategies of the business. This is known as an “optimized” data center.

An optimized data center may have the attributes shown in column 520e. Decisions are now of a strategic nature. Furthermore, IT helps impact the business direction, in direct support of the business. There is a strong alignment of IT with the business units at the planning level. During this phase, the amount invested in the IT infrastructure is significant. However, the return on this investment should be clearly visible at the bottom line in the form of business dividend.

The level of support is anticipatory, in that support issues and problems are anticipated and reacted upon before they impact the business or the end users. This setup requires a high level of sophistication for the automation in place to support this maturity level. Once a support issue is identified, the responses are planned and follow documented procedures.

As mentioned above, automation is prevalent throughout the whole IT organization to allow for automated services to be delivered, resulting in on-time delivery of the required services at the appropriate level of service. These levels of service are measures through technology-level and business-level service levels that are enforced. The IT environment supports the business environment, and as such, the IT environment requires being at a guaranteed level of technology maturity. This implies that leading edge technology is used to stay ahead of the competition, while mitigating the risk of being too leading edge for the competitive advantage. The business and IT environment work together to enhance the business environment.

The use of innovative equipment is prevalent during this stage of maturity for several reasons. First, the equipment needs to support the enterprise view (including standardization and business integration of IT). Second, the IT environment needs to provide the business with a competitive advantage. As an organization advances in this level of maturity, waste is reduced, and the overall value that the IT environment brings in the automation and accuracy of the business cycles increases.

Note that the incremental cost in the progression towards a better data center probably becomes increasingly more expensive as the data center gets closer to the optimized phase. The main reason for this is similar to the law of diminishing returns; smaller incremental improvements will yield smaller enhancements to the environment at ever increasing expenses. These ever increasing expenses are due to the fact that an ever-expanding infrastructure needs to be enhanced and upgraded with new functions and features to enable new functionality. As the costs continue to increase, the return on investment tends to become smaller. The breakeven point differs by data center, based on external factors such as cost of hardware, software, and labor, as well as the initial level of maturity of the data center.

Additionally, as an organization evolves throughout the data center maturity spectrum, the ratio of infrastructure enhancement value and the business value derived from enhancement changes. Initially, the infrastructure derives the most value from any enhancements of the data center, as more standardization of processes and tools occurs. As an organization moves higher into the data center maturity, the incremental value for the infrastructure is diminished, and the business value increases. As an example, once standardization is in place and the operational benefits from this standardization have been obtained, the business will start to see the benefits from this standardization, as new business rules and new business opportunities can be codified and incorporated into the existing infrastructure in a rapid fashion.

A number of implementations have been described. Other implementations are within the scope of the following claims.

What is claimed is:

1. A method for analyzing a data center, the method comprising evaluating the maturity of each of predefined data center categories, wherein:
each category is associated with a data center resource; and
maturity reflects management organization of a category.

2. The method of claim 1, wherein the categories comprise:
physical infrastructure;
information technology environment;
systems management;
globalization;
application development; and
application infrastructure.

3. The method of claim 2, wherein evaluating the maturity of physical infrastructure comprises evaluating the maturity of at least one of building, location, security, disaster recovery capability, processes, service excellence, service level management, standardization, network latency, data access latency, pre-emptive auto-recovery, and data center status monitoring capability.

4. The method of claim 2, wherein evaluating the maturity of information technology environment comprises evaluating the maturity of at least one of technology refresh process, technology refresh implementation, tactical and strategic planning, real-time client business view, and virtual data center.

5. The method of claim 2, wherein evaluating the maturity of systems management comprises evaluating the maturity of at least one of performance management, capacity planning, dynamic resource allocation, single consolidated consoles, and information technology processes.

6. The method of claim 2, wherein evaluating the maturity of globalization comprises evaluating the maturity of at least one of geographic diversity, workload characterization, global standardization, and global processes.

7. The method of claim 2, wherein evaluating the maturity of application development comprises evaluating the maturity of at least one of standardization, application maturity, and application simplicity.

8. The method of claim 2, wherein evaluating the maturity of application infrastructure comprises evaluating the maturity of at least one of high availability and virtual applications.

9. The method of claim 2, wherein the categories further comprise operational infrastructure.

10. The method of claim 9, wherein evaluating the maturity of operational infrastructure comprises evaluating the maturity of at least one of standardization, business continuity, problem and change management, root cause analysis, and lights-out operation.

11. The method of claim 2, wherein evaluating the maturity of a category comprises determining a maturity rating for a component of the category.

12. The method of claim 1, further comprising determining an overall data center rating.

13. The method of claim 12, wherein determining an overall data center rating comprises averaging maturity ratings for the categories.

14. The method of claim 12, further comprising comparing the overall data center rating to a standardized rating.

15. The method of claim 12, further comprising translating the overall rating into business management areas.

16. The method of claim 1, further comprising determining recommendations for improving the data center based on the maturity of at least one category.

17. A system for analyzing a data center, comprising:
a memory operable to store instructions for determining a maturity rating for each of predefined data center categories, with each category being associated with a resource of a data center and the maturity reflecting management organization of the category;
a processor operable to process the instructions to generate a user interface for querying a user for the maturity ratings;
a display device operable to display the user interface; and
an input device operable to detect user commands indicating the maturity ratings.

18. The system of claim 17, wherein the categories comprise:
physical infrastructure;
information technology environment;
systems management;
globalization;
application development; and
application infrastructure.

19. The system of claim 18, wherein the categories further comprise operational infrastructure.

20. The system of claim 17, wherein the processor is further operable to process the instructions to determine an overall data center rating.

21. The system of claim 17, wherein the processor is further operable to process the instructions to determine recommendations for improving a data center based on the maturity of at least one category.

22. An article comprising a machine-readable medium storing instructions operable to cause one or more machines to perform operations comprising determining a maturity rating for each of predefined data center categories, with each category being associated with a resource of a data center and the maturity reflecting management organization of the category.

23. The article of claim 22, wherein the categories comprise:
physical infrastructure;
information technology environment;
systems management;
globalization;
application development; and
application infrastructure.

24. The article of claim 23, wherein the categories further comprise operational infrastructure.

25. The article of claim 22, wherein the instructions are further operable to cause one or more machines to perform operations comprising determining an overall data center rating.

26. The article of claim 22, wherein the instructions are further operable to cause one or more machines to perform operations comprising determining recommendations for improving a data center based on the maturity of at least one category.

27. A method for analyzing a data center, the method comprising:
determining an overall data center rating by averaging the maturity ratings for predefined data center categories comprising physical infrastructure, information technology environment, systems management, globalization, application development, application infrastructure, and operational infrastructure, the maturity rating reflecting the management organization of the category, wherein:
physical infrastructure comprises building, location, security, disaster recovery capability, processes, service excellence, service level management, standardization, network latency, data access latency, pre-emptive auto-recovery, and data center status monitoring capability,
information technology environment comprises technology refresh process, technology refresh implementation, tactical and strategic planning, real-time client business view, and virtual data center,
systems management comprises performance management, capacity planning, dynamic resource allocation, single consolidated consoles, and information technology processes,
globalization comprises geographic diversity, workload characterization, global standardization, and global processes,
application development comprises standardization, application maturity, and application simplicity,
application infrastructure comprises high availability and virtual applications, and
operational infrastructure comprises standardization, business continuity, problem and change management, root cause analysis, and lights-out operation;
comparing the overall data center rating to a standardized rating;
translating the overall rating into business management areas; and
determining recommendations for improving the data center based on the maturity of at least one category.
